(19) United States
(12) Patent Application Publication
(10) Pub. No.: US 2009/0103316 A1
(43) Pub. Date: Apr. 23, 2009

(54) CHASSIS FOR A LIGHT SOURCE UNIT, A LIGHT SOURCE UNIT INCLUDING THE CHASSIS, AND A DISPLAY DEVICE INCLUDING THE CHASSIS

(75) Inventor: Kentaroh Aoki, Tokyo (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 11/917,826

(22) PCT Filed: Jun. 16, 2006
(86) PCT No.: PCT/JP2006/312177

§ 371 Date: Mar. 14, 2008

(30) Foreign Application Priority Data
Jun. 16, 2005 (JP) 2005-176762

(51) Int. Cl. F21V 15/00

(52) U.S. Cl. 362/362

(57) ABSTRACT

To provide a chassis for a light source unit, a light source unit including the chassis, and a display device including the chassis, the chassis being capable of holding a light source placed on the chassis so as to prevent the light source from falling off the chassis without attaching side holders to the chassis. A backlight chassis 11, on a wall surface of which the light source 12 is to be placed, includes holding members 111a and 112a arranged to hold a holder 121a attached to the end of the light source 12 so that the light source 12 does not easily fall off the backlight chassis 11.

### BACKGROUND OF THE INVENTION

1. Field of the Invention

The present invention relates to a chassis for a light source unit, a light source unit including the chassis, and a display device including the chassis, and specifically relates to a chassis which is used for a light source unit preferably used as a light source for a non-self-emissive display such as a liquid crystal display device, a light source unit including the chassis, and a display device including the chassis.

2. Description of the Related Art

A display device including a non-self-emissive display panel, for example, a liquid crystal display device including a translucent liquid crystal display panel, generally includes a light source unit incorporating a light source placed behind the liquid crystal display panel.

FIG. 6 is an exploded perspective view schematically illustrating the structure of a conventional liquid crystal display device including a translucent liquid crystal display panel. Alight source unit 9 used for the liquid crystal display device includes a chassis 91, light sources 92, a light source driving circuit board 98 which drives the light sources 92, and side holders 93 having functions of holding the light sources 92. The light sources 92 are used while holders 921 are attached to their ends.

A brief description of the structure for installing the light sources 92 in the light source unit 9 will be provided. On one surface of the chassis 91 (the surface facing toward the top of the FIG. 6), the light sources 92 are arranged in parallel, and the side holders 93 are attached to the chassis 91 so as to cover the holders 921 and their vicinities. The side holders 93 are fastened to the chassis by screws (not shown). On the other surface of the chassis 91 (the surface facing toward the bottom of the FIG. 6), the light source driving circuit board 98 is placed, and electrical cables 922 which are drawn from the ends of the light sources 92 are connected to a connector (not shown) provided to the light source driving circuit board 98.

Since the light sources 92 are installed as such, the holders 921 which are attached to the ends of the light sources 92 are housed in spaces between the chassis 91 and the side holders 93 and the light sources 92 are held on the chassis 91. Accordingly, once the side holders 93 are fastened to the chassis 91, the light sources 92 are held by the side holders 93 and do not fall off the chassis 91 even when the surface of the chassis 91 on which the light sources 92 are placed is placed face down.

In addition, in order to fasten the holders 921 to the chassis 91, a locking mechanism such as a hook portion arranged to lock the chassis 91 is provided to the holders 921 (see Japanese Patent Application Unexamined Publication No. 2005-005271). By providing such a locking mechanism to the holders 921, the light sources 92 can be prevented from falling off the chassis 91.

Incidentally, during assembly of the light source unit 9, after the light sources 92 are placed on the chassis 91 and connected to the light source driving circuit board 98, an inspection is actually performed to know whether the installed light sources 92 emit light properly. If any of the light sources 92 emit light improperly, the improper light sources are replaced with proper light sources.

Firstly, since the light source driving circuit board 98 is placed on the surface of the chassis 91, operations to connect and disconnect the light sources 92 and the light source driving circuit board 98 are carried out while the surface of the chassis 91 on which the light source driving circuit board 98 is placed is placed face up mainly from the viewpoint of workability. For this reason, it is necessary for the side holders 93 to be fastened to the chassis 91 in advance so that the light sources 92 placed on the surface of the chassis 91 which is placed face down do not fall off the chassis 91 during the operations.

Then, as a result of the inspection, if the installed light sources 92 include any light sources which emit light improperly, operations to unfasten the side holders 93 from the chassis 91, to replace the improper light sources with proper light sources and to refasten the side holders 93 to the chassis 91 are required. In this case, if the side holders 93 are fastened to the chassis 91 by the screws, operations to loosen and tighten the screws are required for unfastening and refastening of the side holders 93 from and to the chassis 91 which are required for the replacement of the light sources 92. However, loosening and tightening the screws are time-consuming operations, so that there arises a problem of time-consuming installation process of the light sources 92 if any of the light sources 92 emit light improperly.

Meanwhile, if the holders 921 are provided with the hook portions, the holders 921 have a complicated shape. In addition, the holders 921 need to be prepared for exclusive use, and the chassis 91 needs to be formed so as to conform to the shape of the hook portions provided to the holders 921.

### SUMMARY OF THE INVENTION

In order to overcome the problems described above, preferred embodiments of the present invention provide a chassis for a light source unit, and a light source unit including the chassis, and a display device including the chassis, the chassis being capable of holding a light source so as to prevent the light source from falling off the chassis without attaching side holders to the chassis even when the surface of the chassis on which the light source is placed is placed face down, or being capable of holding the light source so as to prevent the light source from falling off the chassis without providing a holder attached to the light source with a mechanism for preventing the light source from falling off the chassis.

According to a preferred embodiment of the present invention, the chassis for a light source unit includes a holding member placed on a wall surface thereof and arranged to hold the holder attached to the light source so as to prevent the light source from falling off the chassis.

In this case, it is preferable that the holding member includes a locking piece extending parallel to the wall surface on which the holder is to be placed, and capable of locking the top surface of the holder placed on the chassis.

It is also preferable that the holding member is unitary molded with the wall surface on which the holder is to be placed. For example, if the wall surface is made from a metal plate material, the holding member is unitary molded with the wall surface by subjecting the material to press working, and if the wall surface is made from a synthetic resin material, the holding member is unitary molded with the wall surface by subjecting the material to injection molding.

Incidentally, for the light source used for the light source unit including the chassis, a linear light source is preferably used.

In addition, for a display panel used for the display device, a display panel which electrically controls polarization properties of a transmitted electromagnetic wave, or a display panel which includes a physical shuttering mechanism for adjusting a transmission amount of an electromagnetic wave is preferably used.

According to the present invention, the chassis includes the holding member being capable of holding the light source so as to prevent the light source from falling off the chassis without attaching the side holders to the chassis, so that it is unnecessary for the side holders to be fastened to the chassis till the end of an inspection performed on the light source placed on the chassis. Accordingly, in replacing a light source which is found to emit light improperly in the inspection with a proper light source, it is unnecessary to carry out operations to unfasten the side holders from the chassis and to refasten the side holders to the chassis, which allows reductions in workloads and working hours.

In addition, since the holding member is provided to the chassis's part, it is unnecessary for the holder to be provided with a special mechanism such as a hook or a concave portion arranged to engage with the chassis, so that a common holder can be used. There is no need to strictly limit the shape and dimensions of the holder, and it is enough for the holder to be formed so as to be held by the holding member.

In this case, when the holding member includes the locking piece extending parallel to the wall surface of the chassis on which the holder is to be placed, the locking piece locks a surface of the holder which is opposite to the surface on which the chassis is placed, so that the light source can be prevented from falling off the chassis more reliably.

In addition, when the holding member is unitary molded with the wall surface of the chassis, a process for manufacturing a separate holding member can be eliminated, so that a reduction in the cost of manufacturing the chassis is delivered. For example, if the chassis is made from the metal plate material, the holding member can be unitary molded with the chassis when the chassis is subjected to the press working, and if the holding member is made from the resin material, the holding member can be unitary molded with the chassis simultaneously when the chassis is subjected to the molding.

### BRIEF DESCRIPTION OF THE DRAWINGS

FIG. 1 is an exploded perspective view schematically illustrating the structure of a light source unit according to a preferred embodiment of the present invention, and a display device incorporating the light source unit.

FIG. 2A is an external perspective view schematically illustrating the structure of holding members provided to a chassis for a light source unit according to a preferred embodiment of the present invention, and FIG. 2B is an external perspective view schematically illustrating the holding members in a state of holding a holder which is attached to a light source.

FIG. 3A is an external perspective view schematically illustrating the structure of holding members provided to the chassis according to another preferred embodiment of the present invention, and FIG. 3B is an external perspective view schematically illustrating the holding members in a state of holding the holder attached to the light source.

FIG. 4A is an external perspective view schematically illustrating the structure of a holder having a mechanism to engage with holding members, and holding members arranged to hold the holder and provided to the chassis according to another preferred embodiment of the present invention, and FIG. 4B is an external perspective view schematically illustrating the holding members in a state of holding the holder.

FIG. 5A is an external perspective view schematically illustrating the structure of a holder having a mechanism to engage with holding members, and holding members arranged to hold the holder and provided to the chassis according to another preferred embodiment of the present invention, and FIG. 5B is an external perspective view schematically illustrating the holding members in a state of holding the holder.

FIG. 6 is an exploded perspective view schematically illustrating a display device incorporating a conventional light source unit.

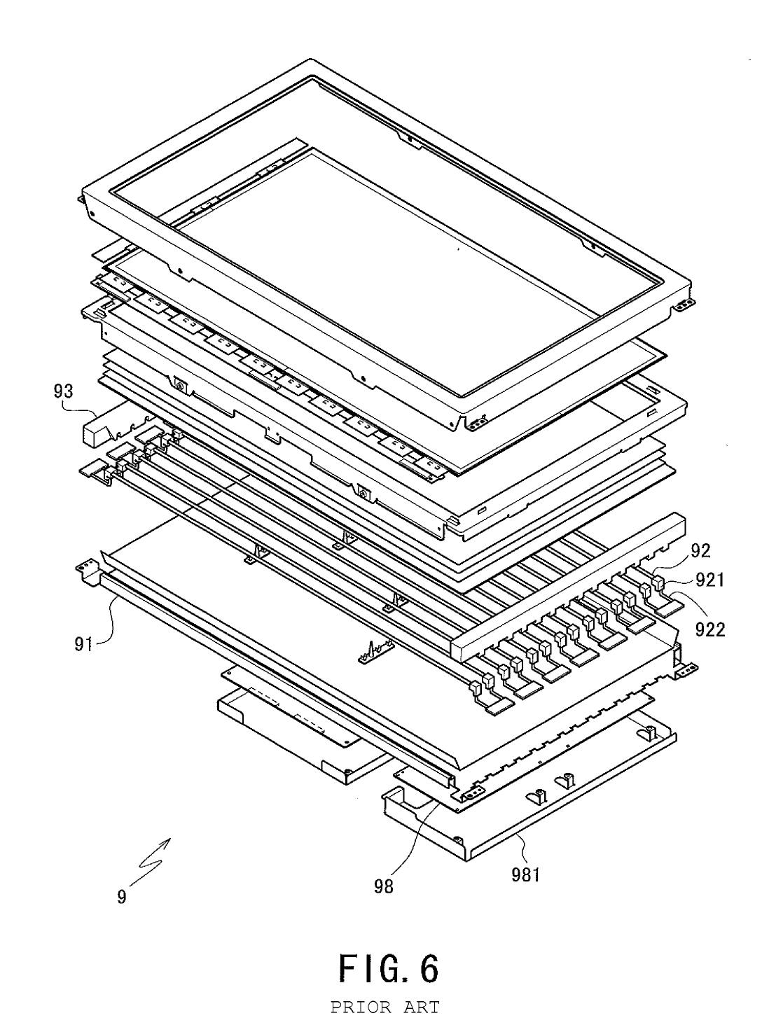

### DETAILED DESCRIPTION OF PREFERRED EMBODIMENTS

A detailed description according to preferred embodiments of the present invention will now be provided with reference to the accompanying drawings. Here, the preferred embodiments of a chassis preferably used for a light source unit to be incorporated into a display device including a translucent liquid crystal display panel are described.

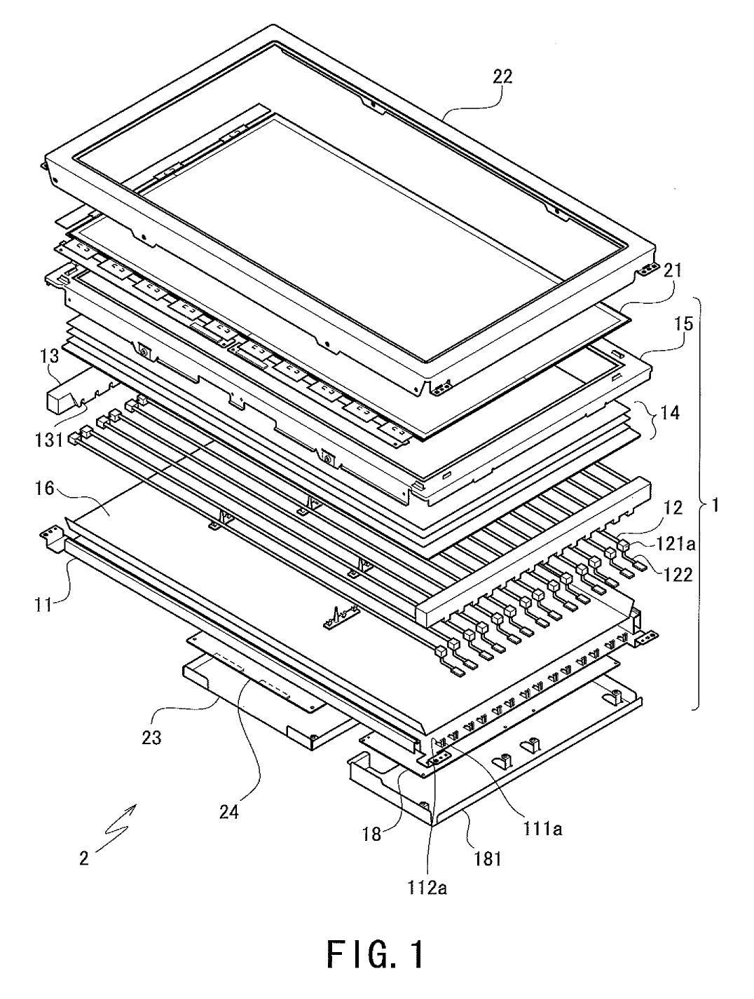

FIG. 1 is an exploded perspective view schematically illustrating the structure for assembling a display device which incorporates a chassis for a light source unit and a light source unit for a display device according to a preferred embodiment of the present invention. Incidentally, in FIG. 1, the light source unit and the display device are illustrated so that their front surfaces face toward the top of FIG. 1, and their back surfaces face toward the bottom of FIG. 1, based on which descriptions will be provided.

First, brief descriptions of a light source unit 1 for a display device and a display device 2 according to the present preferred embodiment of the present invention will be provided with reference to FIG. 1. The light source unit 1 includes a backlight chassis 11 for the light source unit 1, light sources 12, side holders 13 having functions of holding and securing the light sources 12 to the backlight chassis 11, optical sheets 14 arranged to control the properties of light emitted from the light sources 12, and a frame 15 having functions of holding and securing the optical sheets 14 to the backlight chassis 11, where the light sources 12, the side holders 13, the optical sheets 14 and the frame 15 are attached to a front surface of the backlight chassis 11. In addition, the light source unit 1 includes a light source driving circuit board 18 which drives the light sources 12, and a light source driving circuit board cover 181 arranged to cover the light source driving circuit board 18, where the light source driving circuit board 18 and the light source driving circuit board cover 181 are placed on a back surface of the backlight chassis 11, and the light source driving circuit board cover 181 is attached to the backlight chassis 11 so as to cover the light source driving circuit board 18.

The display device 2 includes the light source unit 1, a display panel 21 arranged to display an image, a bezel 22, a control circuit board 23 which controls the display panel 21, and a control circuit board cover 24 arranged to cover the control circuit board 23, where the display panel 21 is placed on a front surface of the light source unit 1, the bezel 22 is placed on a front surface of the display panel 21, and the control circuit board 23 and the control circuit board cover 24 are placed on the back surface of the backlight chassis 11, where the control circuit board cover 24 is attached to the backlight chassis 11 so as to cover the control circuit board 23.

Next, a description of the backlight chassis 11 for the light source unit 1 and the other members which constitute the light source unit 1 will be provided.

The backlight chassis 11 is a member which is preferably made from a metal plate material so as to have a substantially square flat shape by preferably being subjected to press working. The backlight chassis 11 is provided with holding members 111a and 112a which are arranged to hold holders 121a attached to the light sources 12, and are placed at positions where the ends of the light sources 12 are located. A detailed description of the structure of the holding members 111a and 112a will be provided later.

For the light sources 12, light sources of a conventional type can be used. In the present preferred embodiment of the present invention shown in FIG. 1, straight tubular (or linear) cold cathode tubes are used for the light sources 12, which are not limited thereto. For example, linearly formed light sources including fluorescent lamps such as cold cathode tubes and hot cathode tubes, and discharge lamps such as xenon lamps, and linearly formed LEDs are used. Any light sources capable of being used as the light sources 12 for the light source unit 1 may be used, and the type thereof is not limited in particular.

Electrical cables 122 are arranged to be drawn from the ends of the light sources 12, and connected to a connector (not shown) provided to the light source driving circuit board 18. The holders 121a are attached to the ends of the light sources 12. The holders 121a are preferably made from an elastically deformable material such as a rubber-based material and a synthetic resin material. The holders 121a have a substantially cubic shape like a block, inside which through holes are provided, and into the through holes, the ends of the light sources 12 fit. The shape of the holders 121a is not limited in particular. However, it is preferable that the holders 121a have a simple shape such as a simple cubic shape as in the preferred embodiments of the present invention in consideration of easy manufacture or general versatility.

The side holders 13 are unitary molded members preferably made from a synthetic resin material and have a substantially column shape. On back surfaces of the side holders 13, cavities (not shown) and substantially U-shaped notches 131 are provided, and the cavities and outer surfaces of the side holders 13 are communicated by the notches 131. The cavities are formed so that the holders 121a attached to the light sources 12 can be housed therein, and the notches 131 are formed so that main bodies of the light sources 12 can be freely placed inside the notches 131. Accordingly, the side holders 13 can be attached to the backlight chassis 11 so as to cover the ends of the light sources 12 placed on the front surface of the backlight chassis 11. In addition, the side holders 13 are provided with screw holes (not shown) so that the side holders 13 can be fastened to the backlight chassis 11 by screws (not shown). A detailed description of the side holders 13 is omitted because conventional side holders can be basically used for the side holders 13.

For the optical sheets 14, the frame 15, the reflection sheet 16, the light source driving circuit board 18, and the light source driving circuit board cover 181, conventionally used ones can be used. Brief descriptions thereof will be provided. The optical sheets 14 refer to members in the shape of a plate or sheet, or a set of the members, which are arranged to control the properties of light emitted from the light sources 12. To be more specific, the optical sheets 14 are defined by a stack of a diffusion plate, a lens sheet, a polarizing reflection sheet and a diffusion sheet. The frame 15 is a member which is preferably made from a metal plate material so as to have a square shape with an opening by preferably being subjected to press working. The reflection sheet 16 is a member in the shape of a sheet arranged to diffusely reflect the light emitted from the light sources 12, which is preferably made from an expanded PET (polyethylene terephthalate) material in the shape of a sheet. The light source driving circuit board 18 is a circuit board in which an electronic/electric circuit which drives the light sources 12 is established. The light source driving circuit board cover 181 arranged to cover the light source driving circuit board 18 is preferably made from a conductor such as a metal plate material.

Next, descriptions of assembly of the light source unit 1 including the above-described constituent members will be provided.

The reflection sheet 16 is laid on the front surface of the backlight chassis 11, and the light sources 12 are arranged in parallel on a front surface of the reflection sheet 16. At this time, the holders 121a attached to the light sources 12 are held by the holding members 111a and 112a provided to the backlight chassis 11. The light source driving circuit board 18 is placed on the back surface of the backlight chassis 11, and the electrical cables 122 extending from the ends of the light sources 12 are connected to the light source driving circuit board 18.

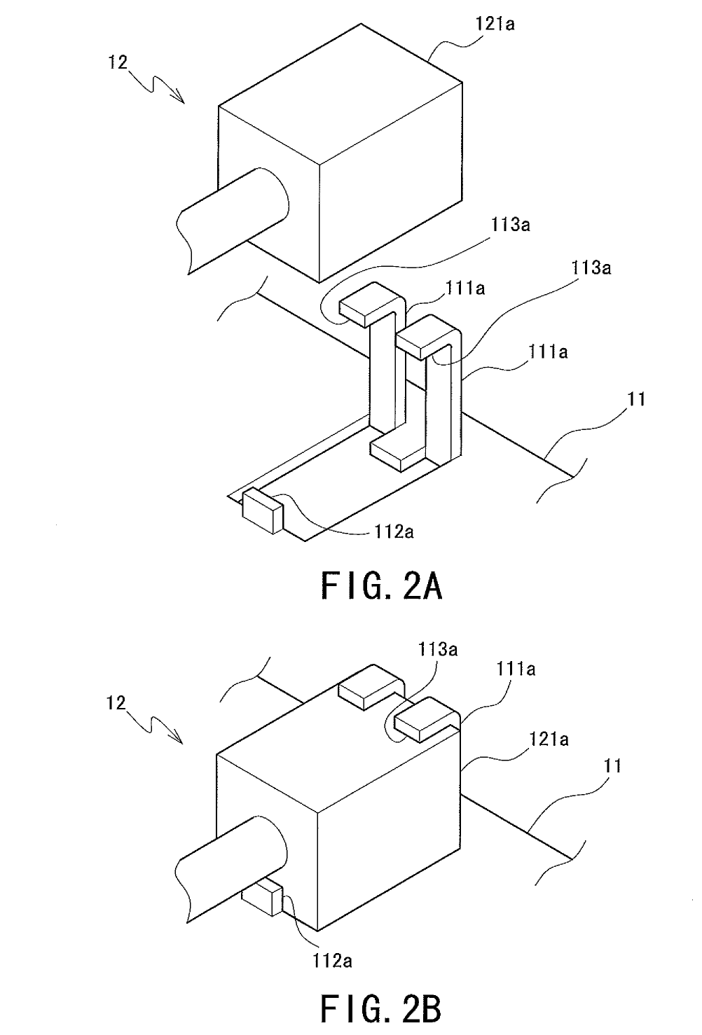

FIG. 2A is an external perspective view schematically illustrating the structure of the holding members 111a and 112a provided to the backlight chassis 11, and FIG. 2B is an external perspective view schematically illustrating the holding members 111a and 112a in a state of holding the holder 121a attached to the light source 12. Besides, in FIGS. 2A and 2B, the electrical cable 122 drawn from the end of the light source 12 is not illustrated.

As shown in FIG. 2A, the holding member 111a stands almost vertically like a column from a wall surface of the backlight chassis 11 toward the front side. At the top of the holding member 111a, a locking piece 113a extending almost parallel to the wall surface of the backlight chassis 11 is provided. The holding member 112a stands almost vertically from the wall surface of the backlight chassis 11 toward the front side. In FIG. 2A, the holding members 111a and 112a are arranged to stand along end faces of the holder 121a in a longitudinal direction of the main body of the light source 12.

The holding members 111a and 112a are prepared in the manners as follows. If the backlight chassis 11 is made from the metal plate material and is shaped by being subjected to press working, press working is performed in such a manner that cuts in the shapes of the holding members 111a and 112a are provided to the metal plate material first, and then cut portions of the metal plate material are bent so as to make the holding members 111a and 112a. To prepare the locking piece 113a at the top of the holding member 111a, the holding member 111a is bent so as to be shaped like a hook. Meanwhile, if the backlight chassis 11 is made from a synthetic resin material and is shaped by being subjected to injection molding, the holding members 111a and the 112a are unitary molded with the wall surface of the backlight chassis 11, and the locking piece 113a is also unitary molded therewith at the top of the holding member 111a.

Incidentally, in addition to the above-described unitary molding manners, it is also preferable that the separate holding members 111a and 112a are bonded to the wall surface of the backlight chassis 11. That is, the manners of preparing the holing members 111a and 112a are not limited in particular.

The holder 121a attached to the end of the light source 12 is held by the holding members 111a and 112a as shown in FIG. 2B. To be more specific, the holder 121a is inserted between the holding members 111a and 112a, and a front surface of the holder 121a (i.e., the surface facing toward the top of FIGS. 2A and 2B) is locked by the locking pieces 113a of the holding members 111a. Since the holder 121a is preferably made from the elastically deformable material, the holder 121a can be elastically deformed so as to be inserted into a space surrounded by the holding members 111a, the holding member 112a, and the locking pieces 113a of the holding members 111a. It is also preferable that the insertion is performed by using elastically deformable properties of the holding members 111a and 112a.

By using the holding members 111a and 112a as such, the holder 121a can be held only by being inserted between the holding members 111a and 112a. Accordingly, even when the backlight chassis 11 is inverted and the surface on which the light source 12 is placed is placed face down, the light source 12 does not fall off the backlight chassis 11 due to its own weight. Especially, since the locking pieces 113a provided to the holding members 111a lock the front surface of the holder 121a, the light source 12 is reliably prevented from falling off the backlight chassis 11.

Hereinafter, the descriptions are continued with referring to FIG. 1. The electrical cables 122 drawn from the ends of the light sources 12 are connected to the light source driving circuit board 18 which is placed on the back surface of the backlight chassis 11. The electrical cables 122 extending from the ends of the light sources 12 can be drawn to the back surface through openings provided between the holding members 111a and 112a. An operation to connect the light sources 12 and the light source driving circuit board 18 is usually carried out while the back surface of the backlight chassis 11 is placed face up. However, since the holders 121a attached to the light sources 12 are held by the holding members 111a and 112a and the light sources 12 do not fall off the backlight chassis 11, it is unnecessary for the side holders 13 to be attached to the backlight chassis 11 in advance of the operation.

After at least the light sources 12 and the light source driving circuit board 18 are placed on the backlight chassis 11 and are connected to each other, an inspection is performed on each of the light sources 12 in order to know whether it emits light properly. If the light sources 12 include any light sources which emit light improperly, the improper light sources are replaced with proper light sources. Then, after confirming that all the light sources 12 placed on the backlight chassis 11 emit light properly, the side holders 13 are attached to the backlight chassis 11 and fastened thereto preferably by screws.

By providing the holding members 111a and 112a as such to the backlight chassis 11, even when the backlight chassis 11 is inverted and the surface on which the light sources 12 are placed is placed face down, the light sources 12 do not fall off due to their own weight. Accordingly, during the assembly of the light source unit 1, even when the surface of the backlight chassis 11 on which the light sources 12 are placed needs to be placed face down, it is unnecessary for the side holders 13 to be fastened to the backlight chassis 11 till the end of the inspection performed on the light sources 12. Therefore, operations to unfasten and refasten the side holders 13 from and to the backlight chassis 11 in replacing the improper light sources with the proper light sources are not required though conventionally required, allowing reductions in workloads and working hours.

Then, the optical sheets 14 are placed on the front surface of the backlight chassis 11, and the frame 15 is placed on a front surface of the optical sheets 14. The frame 15 is fastened to the backlight chassis 11 preferably by screws. The light source unit 1 is thus assembled.

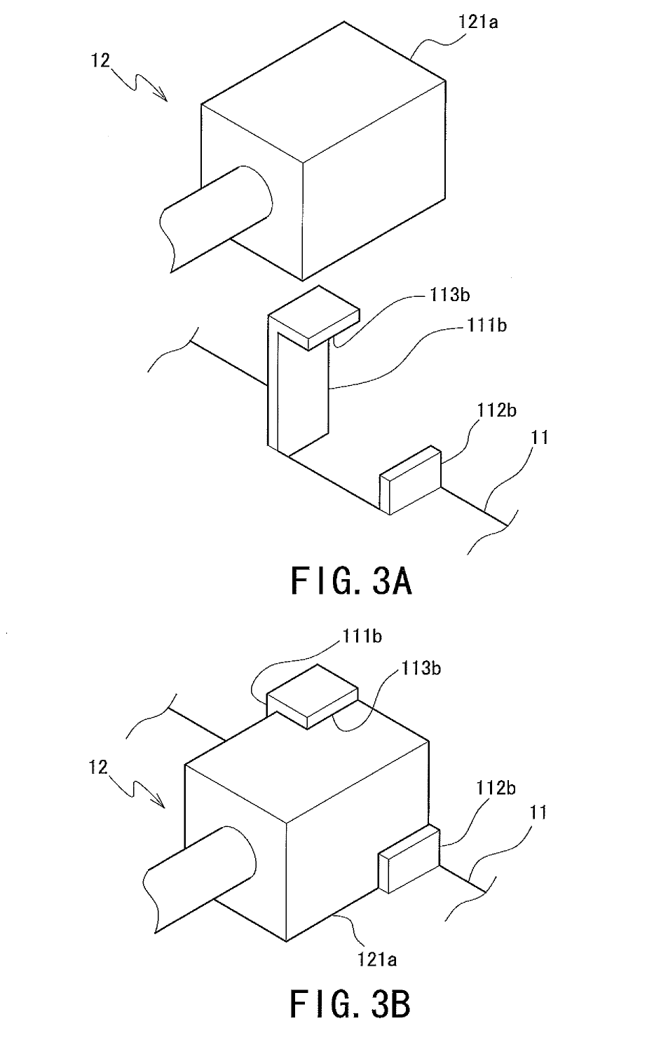

Next, a description of holding members according to another preferred embodiment of the present invention is provided. FIGS. 3A and 3B are views illustrating holding members according to the present preferred embodiment which are provided to the backlight chassis 11. To be more specific, FIG. 3A is an external perspective view schematically illustrating the structure of holding members 111b and 112b which are provided to the backlight chassis 11, and FIG. 3B is an external perspective view schematically illustrating the holding members 111b and 112b in a state of holding the holder 121a attached to the light source 12.

As shown in FIG. 3A, the holding member 111b stands almost vertically from the wall surface of the backlight chassis 11 toward the front side. At the top of the holding member 111b, a locking piece 113b extending almost parallel to the wall surface of the backlight chassis 11 is provided. The holding member 112b stands almost vertically from the wall surface of the backlight chassis 11 toward the front side. The holding members 111b and 112b are arranged to stand along side faces of the holder 121a in the longitudinal direction of the main body of the light source 12. For the manners of preparing the holding members 111b and 112b, the same manners of preparation as the above-described holding members 111a and 112a shown in FIGS. 2A and 2B can be used.

The holder 121a attached to the end of the light source 12 is inserted between the holding members 111b and 112b, and the front surface of the holder 121a (i.e., the surface facing toward the top of FIGS. 3A and 3B) is locked by the locking piece 113b of the holding member 111b as shown in FIG. 3B. The electrical cable 122 extending from the end of the light source 12 is drawn to the back surface of the backlight chassis 11 through a notch provided at the edge of the backlight chassis 11 and is connected to the light source driving circuit board 18.

Owing to this configuration, the holding members 111b and 112b according to the present preferred embodiment have the same function as the above-described holding members 111a and 112a shown in FIGS. 2A and 2B, achieving the same action and effect as the holding members 111a and 112a.

Incidentally, the shapes and dimensions of the holding members 111a and 112a, and the holding members 111b and 112b are not limited in particular. It is preferable only if the holding members 111a and 112a, or the holding members 111b and 112b can hold the light source 12 so as to prevent the light source 12 from falling off the backlight chassis 11 due to its own weight without attaching the side holders 13 to the backlight chassis 11. In order to prevent the light source 12 from falling off the backlight chassis 11 more reliably, it is preferable that the holding member 111a or the holding member 111b includes the locking piece 113a or the locking piece 113b arranged to lock the front surface of the holder 121a, i.e., the surface opposite to the surface in contact with the wall surface of the backlight chassis 11 when the light source 12 is placed thereon.

However, if the holding members 111a and 112a, or the holding members 111b and 112b can prevent the light source 12 from falling off the backlight chassis 11 only by themselves, the locking piece 113a or the locking piece 113b is not always necessary. For example, it is also preferable that, by using the elastically deformable properties of the holder 121a or the holding members 111a and 112a, or the holder 121a or the holding members 111b and 112b, the holder 121a can be elastically engaged in the space between the holding members 111a and 112a, or the holding members 111b and 112b. On contact surfaces between the holder 121a and the holding members 111a and 112a, or between the holder 121a and the holding members 111b and 112b, friction is produced, so that the light source 12 can be prevented from falling off the backlight chassis 11, whereby the necessity of including the locking piece 113a or the locking piece 113b is eliminated.

Next, descriptions of the structure of a holder having a mechanism to engage with holding members, and holding members arranged to hold the holder according to another preferred embodiment of the present invention will be provided.

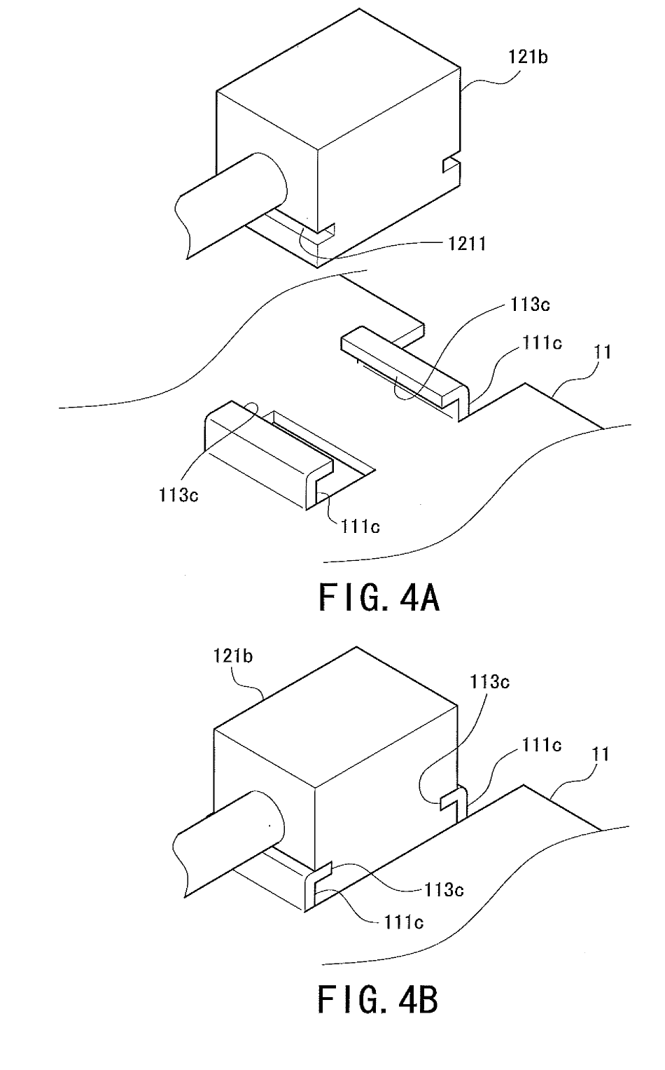

FIG. 4A is an external perspective view schematically illustrating the structure of a holder 121b having a mechanism to engage with holding members, and holding members 111c arranged to hold the holder 121b, and FIG. 4B is an external perspective view schematically illustrating the holding members 111c in a state of holding the holder 121b. In FIG. 4A, the electrical cable 122 drawn from the end of the light source 12 is not illustrated.

As shown in FIG. 4A, a pair of the holding members 111c stand almost vertically from the wall surface of the backlight chassis 11 toward the front side so as to be almost parallel and opposed to each other. The holding members 111c are arranged to stand along end faces of the holder 121b in the longitudinal direction of the main body of the light source 12. At the top of the holding members 111c, locking pieces 113c extending almost parallel to the wall surface of the backlight chassis 11 are provided so as to extend toward each other. The holder 121b is provided with concave portions 1211 on its end faces in the longitudinal direction of the main body of the light source 12, in which the locking pieces 113c of the holding members 111c are to be engaged.

The holder 121b attached to the end of the light source 12 is held by the holding members 111c as shown in FIG. 4B. To be more specific, the holder 121b is inserted between the pair of the holding members 111c, and the locking pieces 113c of the holding members 111c are engaged in the concave portions 1121 on the end faces of the holder 121b so as to lock the holder 121b. Therefore, the holder 121b is held by the backlight chassis 11 so as not to easily fall off, and the same action and effect as described above are achieved.

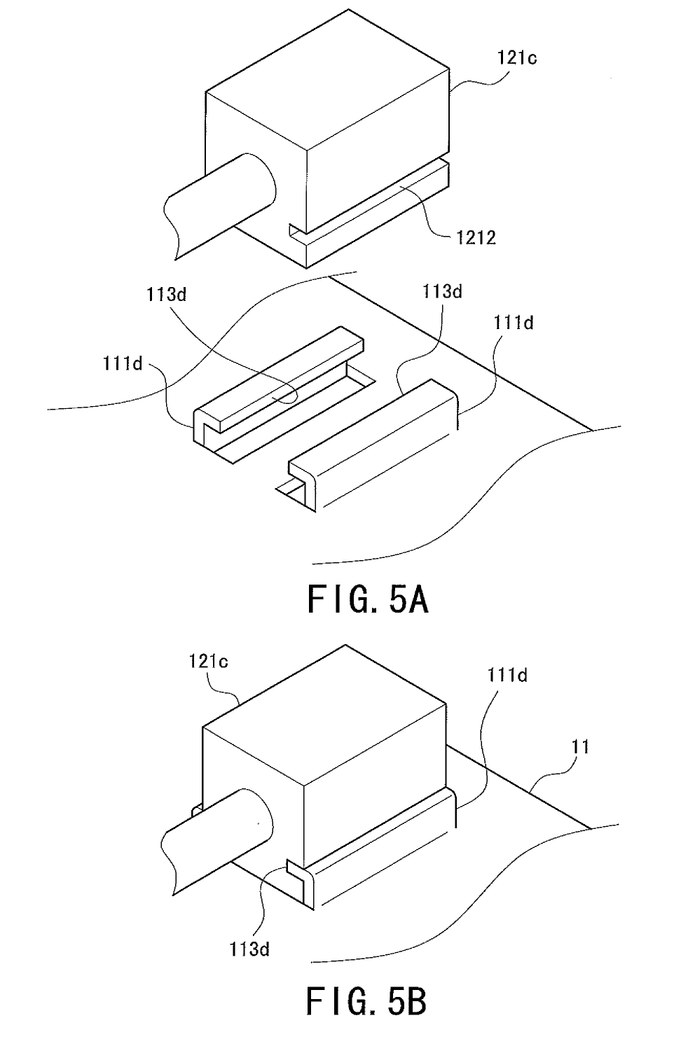

Incidentally, the surfaces on which the concave portions 1121 are provided and the direction of the holding members 111c are not limited to the ones shown in FIGS. 4A and 4B. It is also preferable that the holding members 111c stand along side faces of the holder 121b in the longitudinal direction of the main body of the light source 12. FIGS. 5A and 5B are views illustrating a holder and holding members according to another preferred embodiment of the present invention. To be more specific, FIG. 5A is an external perspective view schematically illustrating the structure of a holder 121c having a mechanism to engage with holding members, and holding members hid arranged to hold the holder 121c, and FIG. 5B is an external perspective view schematically illustrating the holding members 111d in a state of holding the holder 121c.

As shown in FIG. 5A, the holding members 111d stand along side faces of the holder 121c in the longitudinal direction of the main body of the light source 12. At the top of the holding members 111d, locking pieces 113d extending almost parallel to the wall surface of the backlight chassis 11 are provided so as to extend toward each other. The holder 121c is provided with concave portions 1212 on its side faces in the longitudinal direction of the main body of the light source 12, in which the locking pieces 113d of the holding members hid are to be engaged.

For the manners of preparing the holding members 111c and the holding members 111d, the same manners of preparation as the above-described holding members 111a and 112a can be used, and descriptions thereof are omitted. In addition, for the other configuration, the same configuration as described in the case of using the holder 121a which has no concave portions can be used, so that a description thereof is omitted. With such a configuration, the same action and effect as described above can be achieved.

Next, a description of the display device 2 including the above-described light source unit 1 is provided with referring to FIG. 1. In the display device 2, the display panel 21 is placed on the front surface of the light source unit 1 and the bezel 22 is placed on the front surface of the display panel 21. The bezel 22 is fastened to the frame 15 preferably by screws (not shown). The control circuit board 23 which controls the display panel 21 is placed on the back surface of the backlight chassis 11, and the control circuit board cover 24 arranged to cover the control circuit board 23 is attached thereto.

For the display panel 21, a display panel which electrically controls polarization properties of a transmitted electromagnetic wave is preferably used. To be more specific, a conventional translucent liquid crystal display panel is preferably used. In addition, for the control circuit board 23 which controls the display panel 21, a conventional control circuit board can be preferably used. Accordingly, detailed descriptions thereof are omitted. The bezel 22 is a member which is preferably made from a metal plate material so as to have a square shape with an opening by being subjected to press working. The control circuit board cover 24 arranged to cover the control circuit board 23 is preferably made from a conductor such as a metal plate material and is shaped by being subjected to press working.

For the display panel 21, a display panel which includes a physical shuttering mechanism for adjusting a transmission amount of an electromagnetic wave is also preferably used. To be more specific, a DMD (digital michromirror device) display is preferably used. In the DMD display, mirrors or shutters are preferably arranged in a checkered pattern on a panel device. In addition, the shape of the mirrors or the shutters is not limited to a square shape which is commonly used, and various shapes including a triangular shape and a round shape are also preferable.

The foregoing description of the preferred embodiments and the implementation example of the present invention has been presented for purposes of illustration and description with reference to the drawings. However, it is not intended to limit the present invention to the preferred embodiments, and modifications and variations are possible as long as they do not deviate from the principles of the present invention.

For example, the shape and the number of the holding members are not limited to the ones in the preferred embodiments. In addition, the positions where the holding members are placed are not limited to the wall surface of the backlight chassis.

1-9. (canceled)

10: A chassis for a light source unit, on a wall surface of which a light source is to be placed, the chassis comprising a holding member placed on the wall surface and arranged to hold a holder attached to an end of the light source.

11: The chassis according to claim 10, wherein the holding member comprises a locking piece extending parallel to the wall surface and arranged to lock a surface of the holder which is opposite to a surface of the holder facing the wall surface.

12: The chassis according to claim 10, wherein the holding member is unitary molded with the wall surface.

13: The chassis according to claim 10, wherein the holding member is made from any one of a metal material and a resin material.

14: A light source unit comprising:
the chassis according to claim 10; and
the light source to the end of which the holder is attached, wherein
the holding member provided to the chassis holds the holder.

15: The light source unit according to claim 14, wherein the light source is a linear light source.

16: A display device comprising:
a light source unit including:
the chassis according to claim 10; and
the light source to the end of which the holder is attached; wherein
the holding member provided to the chassis holds the holder; and
a display panel.

17: The display device according to claim 16, wherein the display panel electrically controls polarization properties of an electromagnetic wave transmitted through the display panel.

18: The display device according to claim 16, wherein the display panel includes a physical shuttering mechanism for adjusting a transmission amount of an electromagnetic wave.
